(19) United States
(12) Patent Application Publication
(10) Pub. No.: US 2011/0235378 A1
(43) Pub. Date: Sep. 29, 2011

(54) POWER SUPPLY SYSTEM FOR ELECTRONIC DEVICE

(75) Inventor: KUANG-LIANG TANG, Tu-Cheng (TW)

(73) Assignee: HON HAI PRECISION INDUSTRY CO., LTD., Tu-Cheng (TW)

(21) Appl. No.: 12/791,034

(22) Filed: Jun. 1, 2010

(30) Foreign Application Priority Data
Mar. 24, 2010 (CN) 201010131547.7

(51) Int. Cl. H02M 7/02

(52) U.S. Cl. 363/84

(57) ABSTRACT

A power supply system includes an AC power source, a converter, a relay switch, and a waveform monitoring circuit. The AC power source provides an AC voltage. The converter is capable of converting the AC voltage into a DC voltage. The relay switch is connected between the AC power source and the converter. The waveform monitoring circuit is connected to the AC power source, and monitors a waveform of the AC voltage provided by the AC power source. The waveform monitoring circuit is connected to the relay switch, and turns on the relay switch when an absolute value of an instantaneous voltage of the AC voltage is not bigger than a threshold voltage.

### BACKGROUND

1. Technical Field

The present invention relates to a power supply system, more particularly to a power supply system for an electronic device.

2. Description of Related Art

Inrush current, or input surge current, refers to the maximum, instantaneous input current drawn by an electrical device when it is first turned on. For example, at the moment a computer is powered on, a power supply of the computer incurs high inrush currents until it is fully powered up. If the inrush current is too great, the power supply is easily damaged.

For protecting the power supply from being damaged by inrush current, high quality and high cost electronic components, such as resistors, capacitors, inductors, and diodes, are used in the power supply. However, that increases a total cost of the power supply, and directly increases a cost of the electrical device equipped with the power supply.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a power supply system for an electronic device in accordance with an embodiment.

FIG. 2 is a wave diagram of an AC voltage provided by an AC power source of the power supply system of FIG. 1.

FIG. 3 is a block view of a power supply system in accordance with another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

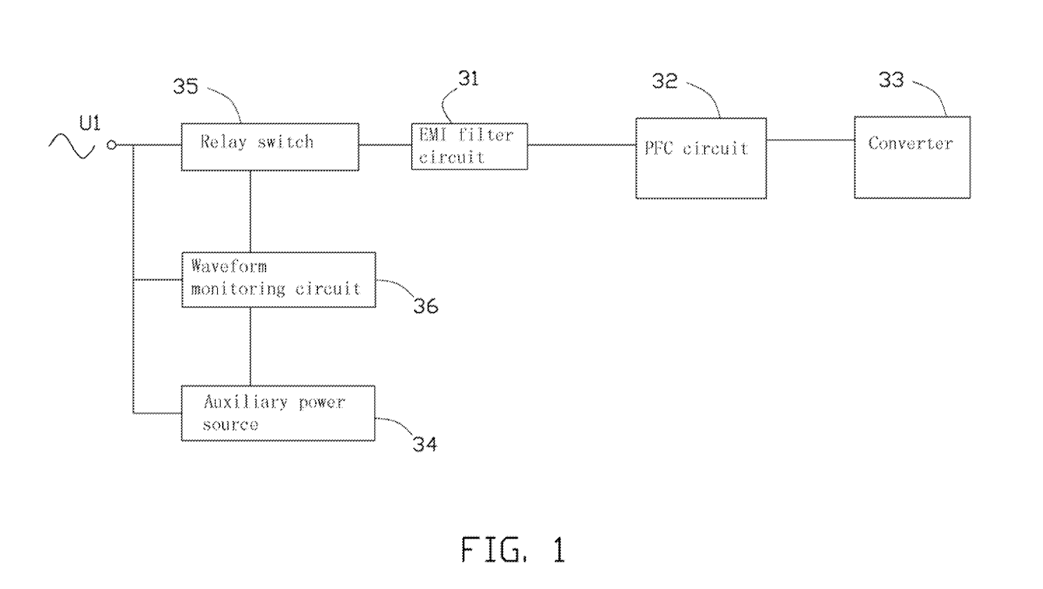

Referring to FIG. 1, a power supply system for an electronic device in accordance with an embodiment of the present disclosure, includes an Alternating Current (AC) power source U1, an Electro Magnetic Interference (EMI) filter circuit 31, a power factor correction (PFC) circuit 32, a converter 33, an auxiliary power source 34, a relay switch 35, and a waveform monitoring circuit 36.

The AC power source U1 provides an AC voltage for the power supply system. The EMI filter circuit 31 is connected to the AC power source U1 via the relay switch 35. The EMI filter circuit 31 is capable of filtering noise in the AC voltage provided by the AC power source U1.

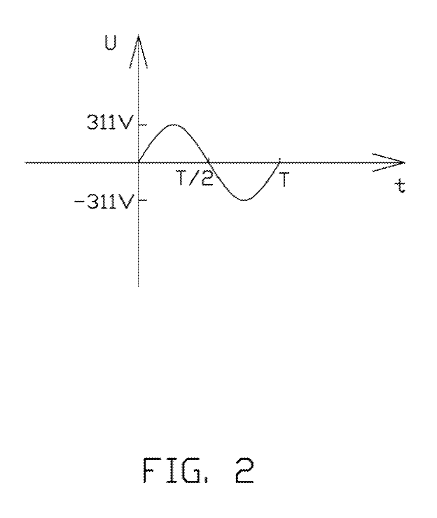

The waveform monitoring circuit 36 is connected to the AC power source U1, and monitors a waveform of the AC voltage provided by the AC power source U1. Referring to FIG. 2, in one embodiment, a waveform of the AC voltage provided by the power source U1 is shown. The waveform of the AC voltage is a sine wave, whose maximal value is about 311 volt. The waveform monitoring circuit 36 further connects to the relay switch 35, and controls turning on or off the relay switch 35 according to a waveform of the AC voltage. The auxiliary power source 34 is connected to the AC power source U1, and is supplied by the AC power source U1. The auxiliary power source 34 provides power to the waveform monitoring circuit 36.

The PFC circuit 32 is connected to the EMI circuit 31. The converter 33 is connected to the PFC circuit 32. The converter 33 is capable of converting the AC voltage into DC voltage.

When the power supply system is in work mode, the waveform monitoring circuit 36 monitors a wave of the AC voltage provided by the AC power source U1. The waveform monitoring circuit 36 controls turning on the relay switch 35 when an instantaneous voltage of the AC voltage is zero. Then, the AC power source U1 starts to provide power for the power supply system. Because the initial voltage of the AC voltage inputted in the power supply system is zero, an inrush current generated in the power supply system is very small. Therefore, the power supply system is protected from being damaged by the inrush current.

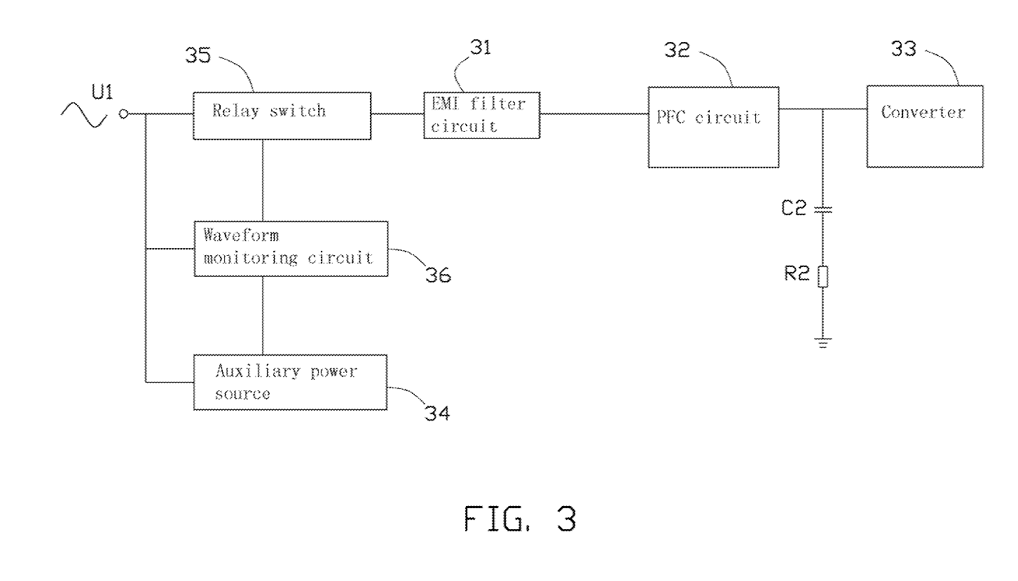

Referring to FIG. 3, another embodiment of a power supply system is shown. In the embodiment of FIG. 3, a resister-capacitor circuit (RC circuit) is added to the embodiment of FIG. 1. The RC circuit includes a capacitor C2 and a resistor R2. One end of the capacitor C2 is connected to a connection node of the PFC circuit 32 and the converter 33. The other end of the capacitor C2 is connected to ground via the resistor R2. When the relay switch 35 is turned on at the time of the instantaneous voltage of the AC voltage being zero, the RC circuit works to reduce the inrush current generated in the power supply system.

In the above embodiments, the AC power source U1 starts to provide power when the instantaneous voltage of the AC voltage is zero. Therefore, the inrush current is very small. Furthermore, in the present disclosure, the time that the AC power source U1 starts to provide power is not limited to the time that the instantaneous voltage of the AC voltage reaches zero. The AC power source U1 can start providing power when an absolute value of the instantaneous voltage of the AC voltage is not bigger than a threshold voltage, such as 30 volt.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A power supply system, comprising:
an AC power source which provides an AC voltage;
a converter capable of converting the AC voltage into a DC voltage;
a relay switch connected between the AC power source and the converter; and
a waveform monitoring circuit, connected to the AC power source, capable of monitoring a waveform of the AC voltage provided by the AC power source; wherein the waveform monitoring circuit is connected to the relay switch and is capable of turning on the relay switch when an absolute value of an instantaneous voltage of the AC voltage is not bigger than a threshold voltage.

2. The power supply system of claim 1, wherein the threshold voltage is zero.

3. The power supply system of claim 1, wherein the waveform of the AC voltage is a sine wave.

4. The power supply system of claim 1, wherein an auxiliary power source is connected to the waveform monitoring circuit and provides power to the waveform monitoring circuit.

5. The power supply system of claim 4, wherein the auxiliary power source is connected to the AC power source and supplied by the AC power source.

6. The power supply system of claim 1, wherein an EMI filter circuit is connected between the relay switch and the converter and is capable of filtering noise in the AC voltage.

7. The power supply system of claim 6, wherein a power factor correction circuit is connected between the EMI filter circuit and the converter.

8. The power supply system of claim 7, further comprising an RC circuit which comprises a capacitor and a resistor, wherein a first end of the capacitor is connected to a connection node of the power factor correction circuit and the converter, and a second end of the capacitor is connected to ground via the resistor.

9. A power supply system, comprising:
an AC power source which provides an AC voltage;
a converter connected to the AC power source via a relay switch;
a waveform monitoring circuit connected to the relay switch to control on or off of the relay switch; wherein the waveform monitoring circuit is capable of monitoring a waveform of the AC voltage, and turning on the relay switch when an instantaneous value of the AC voltage is zero.

10. The power supply system of claim 9, wherein the waveform of the AC voltage is a sine wave.

11. The power supply system of claim 9, wherein an auxiliary power source is connected to the waveform monitoring circuit and provides power to the waveform monitoring circuit.

12. The power supply system of claim 11, wherein the auxiliary power source is connected to the AC power source and supplied by the AC power source.

13. The power supply system of claim 9, wherein an EMI filter circuit is connected between the relay switch and the converter and is capable of filtering noise in the AC voltage.

14. The power supply system of claim 13, wherein a power factor correction circuit is connected between the EMI filter circuit and the converter.

15. The power supply system of claim 14, further comprising an RC circuit which comprises a capacitor and a resistor, wherein a first end of the capacitor is connected to a connection node of the power factor correction circuit and the converter, and a second end of the capacitor is connected to ground via the resistor.

16. A waveform monitoring circuit comprising:
a circuit connected to a AC power source, capable of monitoring a waveform of an AC voltage provided by the AC power source; wherein the circuit is connected to a relay switch and is capable of turning on the relay switch when an absolute value of an instantaneous voltage of the AC voltage is not bigger than a threshold voltage.
